(19) United States
(12) Patent Application Publication
(10) Pub. No.: US 2026/0300501 A1
(43) Pub. Date: Oct. 1, 2026

(54) METHODS AND SYSTEMS FOR PERFORMING VULNERABILITY DETECTION ON FLIGHT CONTROL SYSTEM OF UNMANNED AERIAL VEHICLE

(71) Applicant: HUAZHONG UNIVERSITY OF SCIENCE AND TECHNOLOGY, Wuhan (CN)

(72) Inventors: Bin YUAN, Wuhan (CN); Ziyi LIANG, Wuhan (CN); Qiankun ZHANG, Wuhan (CN); Kunming WANG, Wuhan (CN); Deqing ZOU, Wuhan (CN); Yong LIU, Wuhan (CN)

(73) Assignee: HUAZHONG UNIVERSITY OF SCIENCE AND TECHNOLOGY, Wuhan (CN)

(21) Appl. No.: 19/248,329

(22) Filed: Jun. 24, 2025

(30) Foreign Application Priority Data
Mar. 27, 2025 (CN) 202510378133.0

(51) Int. Cl. G06F 21/57

(52) U.S. Cl. CPC G06F 21/577; G06F 2221/034

(57) ABSTRACT

The present disclosure provides a method for performing vulnerability detection on a flight control system of an unmanned aerial vehicle (UAV) based on a data flow analysis method and an LLM, comprising: S1, extracting operation function modules associated with user operations in the flight control system via the data flow analysis method, and establishing a library of operation-code mapping relationships; S2, for each operation function module, generating structured natural language semantic descriptions of a code fragment corresponding to the operation function module using the large language model to form a multi-dimensional semantic feature; S3, constructing a combined test scenario and generating a natural language test case based on the combined test scenario by performing a correlation analysis on the multi-dimensional semantic features of the operation function modules; S4, transforming the natural language test case into executable test code via reverse semantic mapping; S5, executing the test code in a UAV simulation environment, obtaining logs of the flight control system while it is running, and performing vulnerability feature extraction and root cause localization using the large language model.

### CROSS-REFERENCE TO RELATED APPLICATION

This application claims priority of Chinese Patent Application No. 202510378133.0, filed on Mar. 27, 2025, the contents of which are entirely incorporated herein by reference.

### TECHNICAL FIELD

The present disclosure relates to the field of intelligent software testing and unmanned aerial vehicle (UAV) safety technologies, and in particular, to methods for performing vulnerability detection on a flight control system of an UAV based on a data flow analysis method and a large language model (LLM).

### BACKGROUND

With the wide application of UAVs in fields such as industrial inspection and logistics transportation, the software reliability of a flight control system of a UAV has become a key safety indicator. The conventional software testing methods for UAVs mainly face the following technical bottlenecks:
1. Insufficient efficiency in test case generation: existing testing methods based on rule engines or symbolic execution tools (such as KLEE and S2E) rely on manually defined test scenarios, making it difficult to cover complex state machine transitions of UAVs (e.g., concurrent execution of emergency braking and waypoint tasks) and multi-modal combinations of sensor inputs; 2. Limited depth in logic vulnerability detection: although static analysis technologies (such as data flow analysis and control flow analysis) are capable of detecting syntactic errors in code, they lack semantic-level verification of business logic rationality. For example, conventional tools cannot identify logical defects such as “a landing instruction is not validated against the current altitude” or “modifying a return point to a no-fly zone and then initiating return”; 3. Weak coverage capability in dynamic testing: existing dynamic testing frameworks (such as the PX4 SITL simulation environment) require manual coding of test scripts and are unable to automatically generate test cases involving multi-operation temporal interference (e.g., modifying a departure point of a UAV during task execution), resulting in a high rate of undetected logic vulnerabilities; 4. Semantic gap between natural language and code: although large language models (such as DeepSeek and the GPT series) have been applied to code generation, current methods have not established domain-specific knowledge constraints for UAVs (e.g., flight mode state machines and parameter ranges of interfaces), leading to poor adaptability of generated test scripts, such as invalid interface call parameters and missing state dependencies.

Therefore, there is an urgent need for a solution for performing vulnerability detection on a flight control system of an UVA based on a data flow analysis method and an LLM.

### SUMMARY

The present disclosure provides a method for performing vulnerability detection on a flight control system of an UVA based on a data flow analysis method and an LLM. By deeply integrating static code parsing with dynamic generative reasoning, the method addresses problems in conventional testing approaches, such as low efficiency in test case generation, insufficient depth in logic vulnerability detection, difficulty in covering multi-modal interaction scenarios, and the semantic gap between natural language and code. Furthermore, a multi-stage large language model processing framework and a natural language intermediate representation technique are proposed, so as to implement a closed-loop process for intelligent generation of test cases, code-based verification, and vulnerability localization, thereby significantly improving the level of automation and the accuracy of vulnerability detection in UAV flight control software.

One or more embodiments of the present disclosure provide a method for performing vulnerability detection on a flight control system of an UVA based on a data flow analysis method and an LLM. The method comprises: S1, extracting operation function modules associated with user operations in the flight control system via the data flow analysis method, and establishing a library of operation-code mapping relationships; S2, for each operation function module, generating structured natural language semantic descriptions of a code fragment corresponding to the operation function module using the large language model to form a multi-dimensional semantic feature; S3, constructing a combined test scenario and generating a natural language test case based on the combined test scenario by performing a correlation analysis on the multi-dimensional semantic features of the operation function modules; S4, transforming the natural language test case into executable test code via reverse semantic mapping; S5, executing the test code in a UAV simulation environment, obtaining logs of the flight control system while it is running, and performing vulnerability feature extraction and root cause localization using the large language model.

In some embodiments of the present disclosure, a system for performing vulnerability detection on a flight control system of an UVA based on a data flow analysis method and an LLM is provided. The system comprises at least one storage device storing a set of instructions and at least one processor configured to communicate with the at least one storage device, wherein when executing the set of instructions, the at least one processor is configured to direct the system to perform operations including: S1, extracting operation function modules associated with user operations in the flight control system via the data flow analysis method, and establishing a library of operation-code mapping relationships; S2, for each operation function module, generating structured natural language semantic descriptions of a code fragment corresponding to the operation function module using the large language model to form a multi-dimensional semantic feature; S3, constructing a combined test scenario and generating a natural language test case based on the combined test scenario by performing a correlation analysis on the multi-dimensional semantic features of the operation function modules; S4, transforming the natural language test case into executable test code via reverse semantic mapping; S5, executing the test code in a UAV simulation environment, obtaining logs of the flight control system while it is running, and performing vulnerability feature extraction and root cause localization using the large language model.

One or more embodiments of the present disclosure provide a computer-readable storage medium, the storage medium storing computer instructions which, when read by a computer, cause the computer to execute the method for performing vulnerability detection on a flight control system of an UVA based on a data flow analysis method and an LLM.

By adopting the above technical solution, the following advantages may be achieved:
1. Enhanced depth in logic vulnerability detection: by combining static code analysis with dynamic behavior simulation, the method is capable of identifying vulnerability patterns caused by consecutive function invocations that are difficult for traditional tools to detect, such as “failing to reset the navigation state after emergency braking” and “concurrent execution of waypoint tasks within a no-fly zone”.
2. Automated closed-loop verification: the entire process from test case generation to vulnerability diagnostics is automated, reducing the need for manual intervention.
3. Deep integration of domain knowledge: through the injection of a JSON interface knowledge base and semantic constraints, the method addresses the adaptability issues between test scripts generated by the large language model and the interface of the flight control system.
4. Advantage of scalability: by updating the interface knowledge base and semantic templates, the method can be rapidly adapted to flight control systems from different UAV manufacturers, supporting cross-platform migration capabilities.

### BRIEF DESCRIPTION OF THE DRAWINGS

In order to better illustrate the technical solution of the present disclosure, the following provides a complete description of the technical solution in the embodiments of the present disclosure with reference to the accompanying drawings. It should be understood that the embodiments described herein are merely a portion of the embodiments of the present disclosure, rather than all possible implementations. All other embodiments obtained by those skilled in the art based on the embodiments of the present disclosure without departing from the scope of the present disclosure, are intended to fall within the protection scope of the present disclosure.

FIG. 1 is a schematic diagram illustrating an application scenario of a vulnerability detection system according to some embodiments of the present disclosure;

FIG. 2 is a block diagram of a processing device according to some embodiments of the present disclosure;

FIG. 3 is a schematic diagram illustrating an overall architecture of a vulnerability detection system according to some embodiments of the present disclosure;

FIG. 4 is a flowchart of an exemplary process for vulnerability detection according to some embodiments of the present disclosure;

FIG. 5 is a flowchart of an exemplary process for constructing a library of operation-code mapping relationships according to some embodiments of the present disclosure;

FIG. 6 is a flowchart of an exemplary process for generating structured natural language semantic descriptions according to some embodiments of the present disclosure;

FIG. 7 is a flowchart of an exemplary process for generating a natural language test case according to some embodiments of the present disclosure.

### DETAILED DESCRIPTION

In order to better illustrate the technical solutions in the embodiments of the present disclosure, brief introductions of the accompanying drawings used in the embodiments are provided below. It is evident that the drawings described below are merely some examples or embodiments of the present disclosure. For those skilled in the art, without departing from the scope of the present disclosure, the present disclosure may be applied to other similar scenarios based on these drawings. Unless otherwise apparent from the context or explicitly stated, the same reference numerals in the drawings refer to the same structures or operations.

It should be understood that the terms “system,” “device,” “unit,” and/or “module” used herein are methods for distinguishing different components, elements, parts, sections, or assemblies at different levels. However, if other terms can achieve the same purpose, such terms may be substituted accordingly.

As used in the present disclosure and the appended claims, unless explicitly indicated otherwise by the context, expressions such as “a,” “an,” “one,” and/or “the” are not intended to indicate singularity only and may also include the plural form. In general, the terms “include” and “including” indicate that the identified steps or elements are included but not exclusive, and that the method or device may also include other steps or elements.

Flowcharts are used in the present disclosure to illustrate operations executed by systems according to embodiments of the present disclosure. It should be understood that the preceding or subsequent operations are not necessarily executed strictly in sequence. Instead, the steps may be performed in reverse order or concurrently. Additional operations may be added to the process, or one or more operations may be removed from the process.

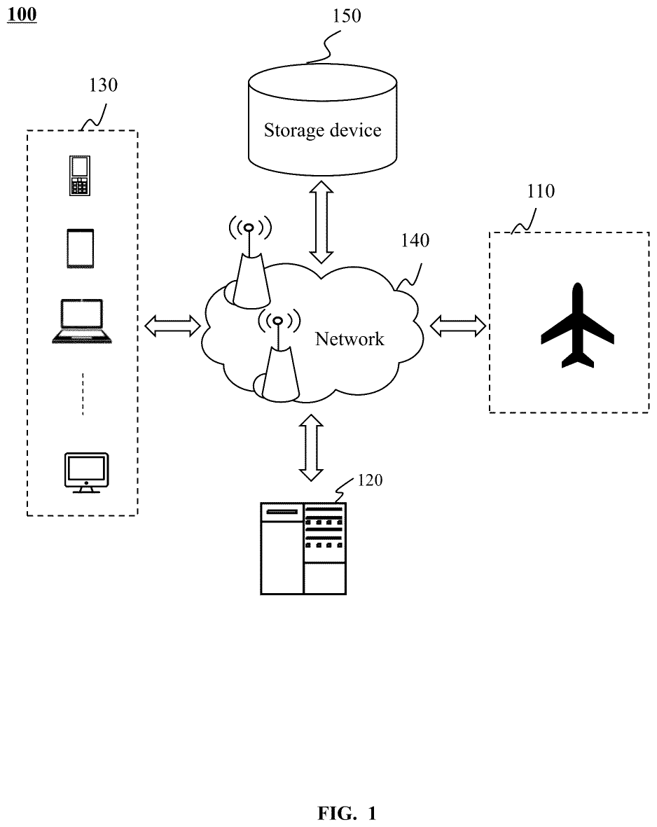

FIG. 1 is a schematic diagram illustrating an application scenario of a vulnerability detection system according to some embodiments of the present disclosure;

In some embodiments, as illustrated in FIG. 1, a vulnerability detection system 100 (hereinafter referred to as the system 100) may include an unmanned aerial vehicle (UAV) 110, a processing device 120, a terminal device 130, a network 140, and a storage device 150. Components of the system 100 may be connected in one or more manners. Merely by way of example, as illustrated in FIG. 1, the UAV 110 may be connected to the processing device 120 via the network 140. As another example, the UAV 110 may be directly connected to the processing device 120.

The UAV 110, also referred to as a drone, refers to an aircraft that operate without a human pilot onboard. In some embodiments, the UAV 110 may be operated using a radio remote control device and an onboard program-controlled apparatus, or may be fully or intermittently autonomously operated by a vehicle-mounted computer.

The processing device 120 may process data and/or information obtained from the UAV 110, the terminal device 130, and/or the storage device 150. For example, the processing device 120 may be configured to establish a library of operation-code mapping relationships. As another example, the processing device 120 may be configured to generate structured natural language semantic descriptions, form multi-dimensional semantic features, and construct a combined test scenario by performing a correlation analysis on the multi-dimensional semantic features, and generate a natural language test case based on the combined test scenario. Furthermore, the processing device 120 may be configured to transform the natural language test case into executable test code, execute the test code in a UAV simulation environment, and obtain logs of the flight control system while it is running, and perform vulnerability feature extraction and root cause localization using a large language model.

In some embodiments, the processing device 120 may include a central processing unit (CPU), a digital signal processor (DSP), a system on chip (SoC), a microcontroller unit (MCU), and/or any combination thereof. In some embodiments, the processing device 120 may include a computer, a user console, a single server, or a server cluster. The server cluster may be centralized or distributed. In some embodiments, the processing device 120 may be local or remote. For example, the processing device 120 may access information and/or data stored in the UAV 110, the terminal device 130, and/or the storage device 150 via the network 140. As another example, the processing device 120 may directly connect to the UAV 110, the terminal device 130, and/or the storage device 150 to access the stored information and/or data. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud architecture, or any combination thereof. In some embodiments, the processing device 120, or a portion thereof, may be integrated into the UAV 110.

The terminal device 130 may be configured to receive user input. For example, the terminal device 130 may be configured to receive a user operation or instruction. The terminal device 130 may include a mobile device, a tablet computer, a notebook computer, or any combination thereof. In some embodiments, the terminal device 130 may be part of the processing device 120.

The network 140 may include any suitable network that facilitates the exchange of information and/or data among components of the system 100. In some embodiments, one or more components of the system 100 (e.g., the UAV 110, the processing device 120, the terminal device 130, and the storage device 150) may be configured to communicate information and/or data with one or more other components of the system 100 via the network 140. In some embodiments, the network 140 may include a wired network and/or a wireless network.

The storage device 150 may be configured to store data, instructions, and/or any other information. In some embodiments, the storage device 150 may be configured to store data obtained from the UAV 110, the terminal device 130, and/or the processing device 120. For example, the storage device 150 may be configured to store a library of operation-code mapping relationships. In some embodiments, the storage device 150 may include a mass storage device, a removable storage medium, a volatile read-write memory, a read-only memory (ROM), or any combination thereof. In some embodiments, the storage device 150 may be implemented on a cloud platform. In some embodiments, the storage device 150 may be connected to the network 140 to communicate with one or more other components of the system 100 (e.g., the UAV 110, the processing device 120, and the terminal device 130). One or more components of the system 100 may access data or instructions stored in the storage device 150 via the network 140. In some embodiments, the storage device 150 may be directly connected to or communicate with one or more other components of the system 100 (e.g., the UAV 110, the processing device 120, the storage device 150, and the terminal device 130). In some embodiments, the storage device 150 may be part of the processing device 120.

It should be noted that the above descriptions are provided merely for illustrative purposes and are not intended to limit the scope of the present disclosure. Those skilled in the art may make various changes and modifications in light of the contents of the present disclosure. Features, structures, processes, and other characteristics described in the exemplary embodiments of the present disclosure may be combined in various ways to form additional and/or alternative exemplary embodiments. However, such changes and modifications shall not be construed as departing from the scope of the present disclosure.

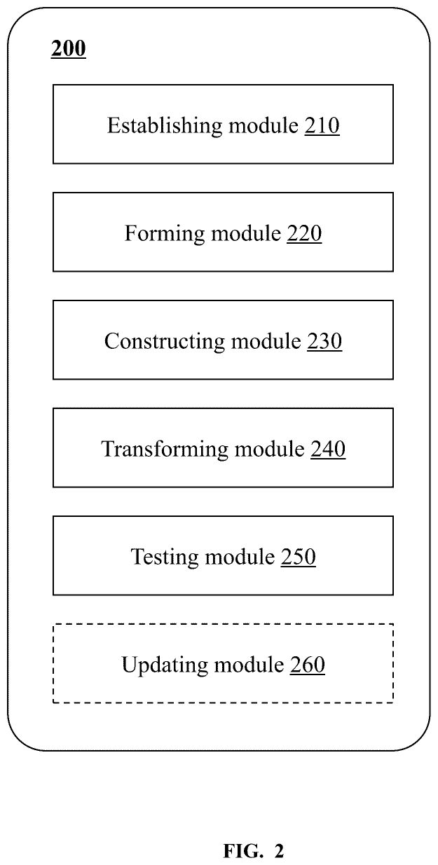

FIG. 2 is a block diagram of a processing device according to some embodiments of the present disclosure; In some embodiments, the processing device 120 may include an establishing module 210, a forming module 220, a constructing module 230, a transforming module 240, a testing module 250, and/or an updating module 260.

The establishing module 210 may be configured to extract operation function modules associated with user operations in the flight control system via the data flow analysis method, and establish a library of operation-code mapping relationships.

The forming module 220 may be configured to generate, for each operation function module, structured natural language semantic descriptions of a code fragment corresponding to the operation function module using the large language model to form a multi-dimensional semantic feature.

The constructing module 230 may be configured to construct a combined test scenario and generating a natural language test case based on the combined test scenario by performing a correlation analysis on the multi-dimensional semantic features of the operation function modules.

The transforming module 240 may be configured to transform the natural language test case into executable test code via reverse semantic mapping.

The testing module 250 may be configured to execute the test code in a UAV simulation environment and obtaining logs of the flight control system while it is running, and perform vulnerability feature extraction and root cause localization using the large language model.

The updating module 260 may be configured to determine an updating parameter based on results of the vulnerability feature extraction and the root cause localization, update a flight control parameter of the UAV based on the updating parameter, and control the UAV to perform a flight mission in accordance with the updated flight control parameter.

In some embodiments, the establishing module 210, the forming module 220, the constructing module 230, the transforming module 240, the testing module 250, and/or the updating module 260 may be separate modules in a system, or may also be implemented by a single module configured to perform functions of two or more of the above modules. For example, the modules may share a common storage module, or each module may have its own storage module. Such variations are intended to fall within the scope of the present disclosure.

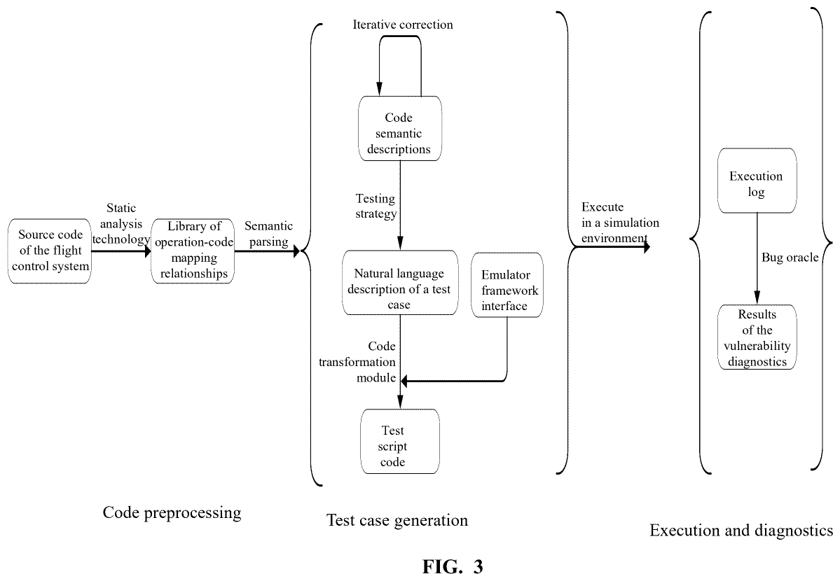

FIG. 3 is a schematic diagram illustrating an overall architecture of a vulnerability detection system according to some embodiments of the present disclosure. As shown in FIG. 3, a vulnerability detection process of the present disclosure includes three stages: code preprocessing, test case generation, and execution and diagnostics.

The code preprocessing stage is an initial core phase in the development process of a flight control system, and is mainly responsible for standardizing raw source code and performing static analysis. Specifically, the code preprocessing stage may be configured to establish a library of operation-code mapping relationships based on static analysis technologies for source code of the flight control system, and extract, based on the library of operation-code mapping relationships, the code fragments corresponding to the operation function modules in different flight phases.

In the test case generation stage, semantic parsing is first performed on the preprocessed code, that is, the code fragments corresponding to the operation function modules, to generate code semantic descriptions, namely, structured natural language semantic descriptions. If the structured natural language semantic descriptions do not meet specified requirements, a reflection mechanism may be triggered to perform iterative correction. Subsequently, based on the structured natural language semantic descriptions and through a testing strategy (i.e., a combined test scenario), a natural language description of a test case (i.e., a natural language test case) may be constructed. Subsequently, with the aid of an emulator framework interface, a natural language description of a test case (i.e., a natural language test case) may be transformed into executable test code using a code transformation module. The transformation process covers a complete chain from code semantic parsing to final generation of the executable test code, thereby implementing the generation of test cases.

In the execution and diagnostics stage, the generated executable test code may be executed in a simulation environment (e.g., a virtual flight scenario) on physical devices to monitor the response of the flight control system in real time. In this stage, the executable test code may be executed in a UAV simulation environment, and logs of the flight control system may be obtained while it is running. A large language model may be utilized to perform vulnerability diagnostics, that is, vulnerability feature extraction and root cause localization. Based on the results of the vulnerability diagnostics (e.g., the vulnerability features and the root cause localization result), an updating parameter may be determined. Based on the updating parameter, a flight control parameter of the UAV may be adjusted, and the UAV may be controlled to perform a flight mission in accordance with the updated flight control parameter.

To implement the above three stages, an overall architecture of the present disclosure may include the following five modules:
1. An operation code fragment extraction module configured to generate a library of operation-code mapping relationships by the data flow analysis method, such as a control flow graph and a data dependency graph. More descriptions regarding the operation code fragment extraction module may be found in S1.
2. A multi-stage large language model processing module configured to generate the multi-dimensional semantic features and the combined test scenarios and to analyze the logs. More descriptions regarding the multi-stage large language model processing module may be found in S2 and S5.
3. A code transformation module, integrating a JSON interface knowledge base with semantic checking rules. More descriptions regarding the code transformation module may be found in S3.
4. A simulation sandbox module configured to obtain the logs. More descriptions regarding the simulation sandbox module may be found in S4.
5. A vulnerability diagnostics module configured to perform the vulnerability feature extraction and the root cause localization using the large language model. More descriptions regarding the vulnerability diagnostics module may be found in S5.

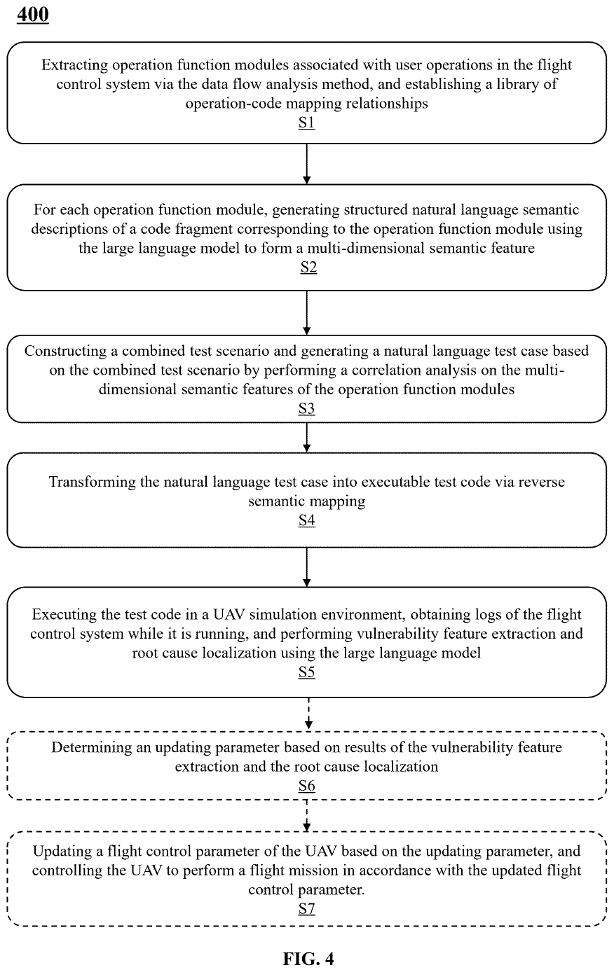

FIG. 4 is a flowchart of an exemplary process for vulnerability detection according to some embodiments of the present disclosure. As shown in FIG. 4, a process 400 includes the following operations. In some embodiments, the process 400 may be executed by the processing device 120.
S1, extracting operation function modules associated with user operations in a flight control system via a data flow analysis method, and establishing a library of operation-code mapping relationships. In some embodiments, S1 may be executed by the establishing module 210.

The flight control system refers to an integrated system configured to control a flight state and behavior of an unmanned aerial vehicle (UAV). The flight control system is responsible for receiving various instructions from a remote controller, a ground station, or a preset program, and for adjusting, in real time, flight parameters such as attitude, position, and speed of the UAV based on sensor data of the UAV. The sensor data includes feedback from a gyroscope, an accelerometer, a GPS module, or the like. The flight control system ensures that the UAV perform various flight missions in a stable and accurate manner, such as takeoff, landing, cruising, hovering at a fixed point, and flying along a pre-defined route.

A user operation refers to an instruction input behavior performed by a user via a remote controller, ground station software, or other control devices, to control the flight control system for executing a specific task or changing a flight state of the UAV. For example, the user operation may include a takeoff operation, a landing operation, a waypoint uploading operation, an emergency braking operation, and a mode switching operation. The user operation is capable of triggering the execution of a corresponding operation function module of the flight control system, thereby causing the UAV to perform corresponding actions, such as taking off, landing, or changing heading. The operation function module associated with a user operation refers to a logical set of code fragments involved in completing a specific user operation instruction, such as takeoff or landing.

The library of operation-code mapping relationships refers to a database configured to establish a correspondence between user operations and code fragments. The data flow analysis method refers to a technical method for identifying and associating a corresponding operation code module for a user operation instruction by tracking a data flow path triggered by the user operation instruction in the flight control system, and is used to determine the complete propagation path of the user operation instruction within the flight control system. In some embodiments, the data flow analysis method may be implemented using a static analysis module of a Low Level Virtual Machine (LLVM) compiler framework.

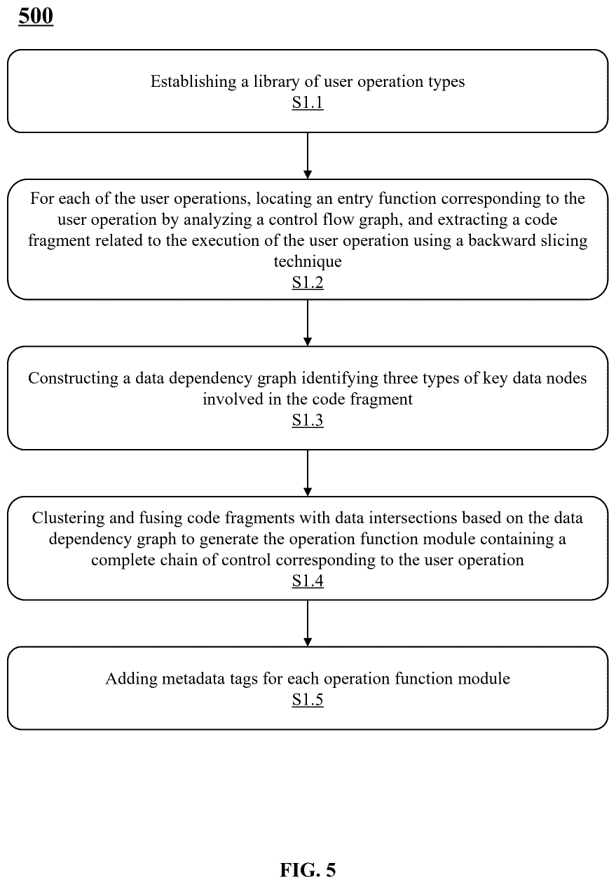

More descriptions regarding the establishment of the library of operation-code mapping relationships may be found in FIG. 5 and related descriptions thereof.
S2, for each operation function module, generating structured natural language semantic descriptions of a code fragment corresponding to the operation function module using the large language model to form a multi-dimensional semantic feature. In some embodiments, S2 may be executed by the forming module 220.

The code fragment corresponding to the operation function module refers to a minimal complete code unit for implementing the user operation function. In some embodiments, the code fragment corresponding to the operation function module may include code fragments corresponding to the operation function modules in different flight phases. The flight phases may include, for example, a takeoff phase, a cruising phase, a hovering phase, and a landing phase. In some embodiments, the processing device 120 may be configured to extract the code fragments corresponding to the operation function modules in different flight phases based on the library of operation-code mapping relationships. Specifically, the processing device 120 may be configured to determine the operation function module(s) to a flight phase based on a first preset table of flight phases and operation function modules, and then determine the code fragments corresponding to the operation function modules associated with different flight phases based on the library of operation-code mapping relationships.

A large language model refers to a pre-trained language model that is fine-tuned for code semantic understanding. In some embodiments, the large language model may include, but is not limited to, one or a combination of GPT (Generative Pretrained Transformer), PaLM (Pathways Language Model), and ERNIE (Enhanced Representation through kNowledge IntEgration).

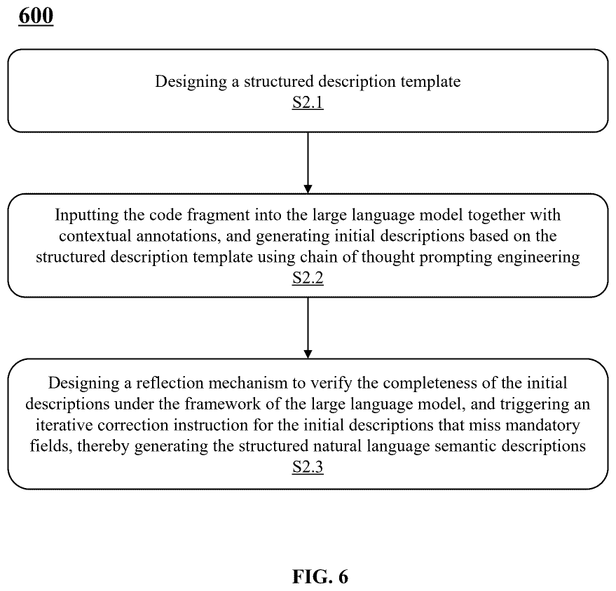

The structured natural language semantic descriptions refer to clear and accurate natural language representations of key information of a code fragment, using specific templates and specifications. The information includes a function of the code fragment, input and output requirements, exception handling mechanisms, or the like. In some embodiments, the processing device 120 may be configured to generate the structured natural language semantic descriptions of a code fragment using the large language model. More descriptions regarding the generation of the structured natural language semantic descriptions may be found in FIG. 6 and related descriptions thereof.

The multi-dimensional semantic features refer to a set of features obtained by analyzing and describing an operation function module from different dimensions. The dimensions may include a state variable of a code fragment, a sensor input, a user command input, or the like. More descriptions regarding the state variable, the sensor input, and the user command input may be found in S1.3 and related descriptions thereof. The multi-dimensional semantic features describe the semantic content of the code fragment in a structured and comprehensive manner, and may provide a basis for understanding, comparing, classifying, and reusing the code fragment.

In some embodiments, the processing device 120 may be configured to form the multi-dimensional semantic features based on the structured natural language semantic descriptions. Specifically, the processing device 120 may treat individual fields within the generated structured natural language semantic descriptions as components of the multi-dimensional semantic features. For example, fields such as a functional intent, an input parameter constraint, an output behavioral expectation, an exception handling mechanism, and a hardware interaction interface may respectively correspond to different dimensions of the multi-dimensional semantic features. The multi-dimensional semantic features may be used for subsequent tasks such as code analysis, test case generation, and cross-module correlation analysis.
S3, constructing a combined test scenario and generating a natural language test case based on the combined test scenario by performing a correlation analysis on the multi-dimensional semantic features of the operation function modules. In some embodiments, S3 may be executed by the constructing module 230.

The combined test scenario refers to a scenario obtained by combining one or more operation function modules, and is used to simulate complex situations that may occur during actual system operation, so as to comprehensively test the overall functionality and interactivity of the system. The combined test scenario takes into account mutual influences and collaborative behavior among different operation function modules, and aims to cover a broader range of system behaviors and potential problems through various combinations of the operation function modules.

The natural language test case refers to a test procedure and an expected result described in a natural language format. The natural language test case uses easy-to-understand language, enabling non-technical personnel to understand the purpose and process of the test. The natural language test case is capable of clearly describing a test scenario, input data, operation steps, and expected results, thereby facilitating test execution and verification

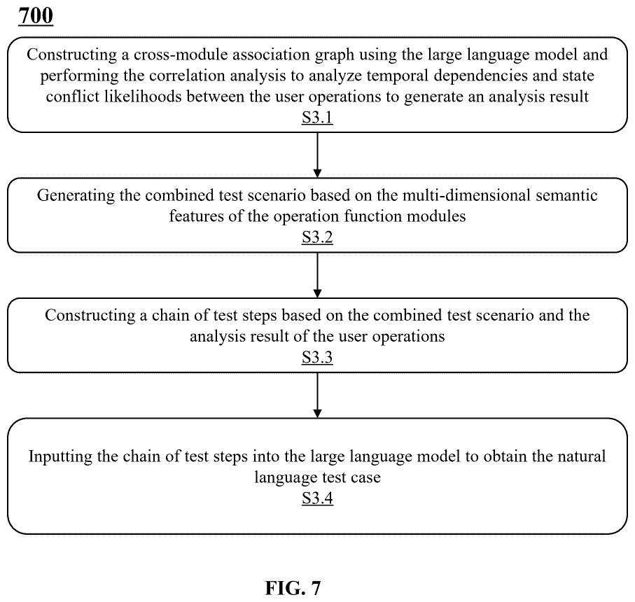

More descriptions regarding S3 may be found in FIG. 7 and related descriptions thereof.
S4, transforming the natural language test case into executable test code via reverse semantic mapping. In some embodiments, S4 may be executed by the transforming module 240.

The reverse semantic mapping refers to a process of converting content described in natural language (such as a natural language test case) into a form that can be understood and executed by a computer (such as code), by analyzing its semantics and logic. The reverse semantic mapping is a reverse conversion operation from natural language to code.

The executable test code refers to code written in a specific programming language that may be executed in a corresponding test environment to perform testing on a system, module, or function. The executable test code includes specific testing steps, input data settings, and judgments of expected results, and can produce a test conclusion after execution.

By performing S4, code-based reconstruction of test logic may be completed. The test logic refers to a series of rules, procedures, and judgment conditions followed during the testing process, which are used to determine how to conduct testing, verify whether a test target meets expected requirements, and handle test results. The test logic serves as the core guiding principle of the testing process.

Specifically, the processing device 120 may be configured to execute the following operations:
S4.1, constructing a JSON interface knowledge base for call functions of functions of the UAV, and providing a standardized interface description for the large language model.

The standardized interface description refers to a documented expression that provides a detailed explanation of interfaces of the call functions of the UAV in accordance with a unified specification and format. The standardized interface description comprises a function name, a parameter type, a parameter semantic constraint, a return value structure, and an exception handling strategy. The parameter semantic constraint comprises explicit annotations of a value range definition, a data type, and a state dependencies.

Specifically, the processing device 120 may be configured to sort out specific functions of the UAV and their corresponding call functions, and clarify functional details implemented by each call function, such as takeoff, landing, and attitude adjustment. Subsequently, in accordance with the specification of the JSON data format, a corresponding JSON file may be created for each call function. In each JSON file, a standardized interface description may be written using fixed fields and formats: a “description” field is used to explain the function of the interface corresponding to the call function; a “parameters” field is used to specify an input parameter name, type, value range, and default value; a “responses” field defines the data structure and a possible return value corresponding to an output; a “call_method” field indicates the invocation method of the interface; an “error_handling” field describes possible error types and handling strategies; and a “constraints” field records usage restrictions of the interface. All JSON files may be integrated into a single knowledge base, in which indexing and classification may be established to support quick retrieval. Finally, the JSON interface knowledge base may be provided to the large language model, enabling the model to accurately understand the usage of the UAV call function interfaces based on the standardized interface descriptions, thereby supporting effective invocation and control of UAV functions.
S4.2, mapping the natural language test case to an executable Python script, so as to obtain standardized code templates for test framework initialization, assertion checking, and exception catching.

The test framework initialization refers to a process of constructing a basic runtime environment for executing test cases. The initialization includes instantiation of a UAV simulation interface, virtualization configuration of sensors and controllers, presetting of testing context such as an initial flight altitude and GPS coordinate, and loading of dependent third-party libraries. The standardized code template for the test framework initialization typically includes class instantiation, injection of environment variables, and startup logic of a hardware abstraction layer (HAL).

The assertion checking refers to an automated verification mechanism for checking whether UAV functions satisfy predefined conditions. The assertion checking may be implemented by using assert statements or dedicated verification functions in code. For example, the assertion checking may verify whether the attitude angle error after executing a flight control instruction is within a threshold, or whether a sensor return value satisfies a physical constraint (such as consistency between accelerometer readings and motion status).

The exception catching refers to intercepting exceptions (e.g., system errors or constraint violations) that may occur during the testing process, such as parameter out-of-range errors or state machine transition conflicts. Such exceptions may be captured in real time using try-except code blocks. The exception catching process may record the error type, stack trace, and the associated flight control context, and may support preset fallback strategies (such as issuing an emergency hovering instruction) to prevent crashes in the simulation environment. The captured results may serve as input data for root cause localization of vulnerabilities.

Specifically, the processing device 120 may be configured to perform in-depth parsing of the natural language test case using natural language processing techniques, so as to accurately extract key information such as a testing objective, operation steps, input data, and an expected result (also referred to as expected state). The expected result refers to the ideal state that the UAV should reach after executing the natural language test case. The expected result includes flight parameters (such as altitude, speed, and heading), device status (such as motor operation and sensor working state), data communication (such as connection with the ground station and normal data transmission), and task execution status (such as waypoint completion and photo/video capture task completion), among others. The expected result serves as a key basis for determining whether the UAV is operating normally and whether the natural language test case has been successfully executed.

In some embodiments, the processing device 120 may analyze the core objective and operation logic of each natural language test case to identify the corresponding impact on the UAV. For example, for the natural language test case “take off to a specified altitude,” the expected result should include successful takeoff of the UAV, reaching the preset altitude and maintaining stable hovering, steady flight attitude, normal communication with the ground station, and the like. Then, the processing device 120 attaches the expected result, expressed in a clear and precise natural language description, directly to the corresponding natural language test case, thereby forming a complete test description with the expected result. Subsequently, when the processing device 120 inputs the natural language test case with the expected result into a relevant model, the model can interpret the objective of the natural language test case based on the explicitly defined expected result.

Subsequently, based on a pre-established library of operation-code mapping relationships, a natural language operation description parsed from the natural language test case may be accurately converted into corresponding Python code fragments. Then, according to a selected test framework (such as unittest or pytest), initial code for the test framework may be automatically generated by combining the Python code fragments in accordance with the specification and requirements of the test framework. In some embodiments, the Python code fragments and/or the initial code may be generated by inputting the natural language operation description and the standardized interface description into the large language model. In some embodiments, the Python code fragments may be generated based on a pre-established library of operation-code mapping relationships. Then, an assertion checking statement may be inserted into the initial code based on the expected result, so as to verify whether an actual execution result meets the expectations. To improve the stability and reliability of the Python script, try-except structures may be used to wrap code segments in the initial code that may raise exceptions, thereby implementing exception catching and enabling appropriate handling in the event of an error. Finally, all parts of the initial code may be integrated and optimized to form a complete and executable Python script, which includes standardized code templates for test framework initialization, assertion checking, and exception catching.
S4.3, implementing a dynamic semantic validation on the executable Python script during code generation.

Specifically, the processing device 120 may be configured to perform a static check on the executable Python script based on the standardized interface description. For example, the static check may be performed on interface calling parameters in the generated executable Python script based on the standardized interface description. The static check comprises checking parameter type matching, enumerated value legitimacy, and state machine consistency. In response to a failed validation result, an iterative correction process on the executable Python script performed by of the large language model may be triggered. For example, error information may be feedback to the large language model, and the large language model may adjust or re-generate the Python code fragments and/or the initial code, so as to correct the executable Python script. During the generation of the executable Python script, the processing device 120 sets targeted checkpoints and validation logic to ensure that the script may simulate the test case operations and verify whether the UAV state meets the expected result.
S5, executing the test code in a UAV simulation environment, obtaining logs of the flight control system while it is running, and performing vulnerability feature extraction and root cause localization using the large language model. In some embodiments, S5 may be executed by the analysis module 250.

The UAV simulation environment refers to a virtual system that simulates a UAV and its operating environment using computer software. The UAV simulation environment is capable of simulating flight dynamics characteristics of the UAV, such as flight attitude, speed, and acceleration. The UAV simulation environment may also simulate various flight scenarios, including different weather conditions (e.g., sunny, rainy, or windy) and geographic environments (e.g., urban areas, mountainous regions, or plains). Additionally, the UAV simulation environment may simulate communication and interaction between the UAV and a ground station, other aerial vehicles, or surrounding devices. Furthermore, the UAV simulation environment may support modeling and simulation of various components of the UAV system, such as the flight control system, sensors, and propulsion system, to enable comprehensive testing and evaluation of UAV performance, functionality, and the effectiveness of various control algorithms.

In some embodiments, the processing device 120 may be configured to generate a test parameter corresponding to the combined test scenario based on the temporal dependencies and the state conflict likelihoods.

The test parameter defines the operation function modules to be tested in the combined test scenario and the execution sequence of these operation function modules. The test parameter may further include flight parameters of the UAV when the operation function modules in the combined test scenario are executed, such as a flight altitude, a speed, a direction, and an environmental condition (e.g., a wind speed and a wind direction).

Specifically, the processing device 120 may be configured to randomly generate a plurality of candidate test parameters.

Furthermore, the processing device 120 may be configured to determine test priorities of the plurality of candidate test parameters based on the temporal dependencies and the state conflict likelihoods, in combination with historical flight data of the UAV. The test priorities refer to execution orders of the candidate test parameters.

Merely by way of example, for each candidate test parameter, a count of flight control operations that do not satisfy the temporal dependencies may be denoted as K1, a count of flight control operations with state conflict likelihood may be denoted as K2, and a total count of historical occurrences of each flight control operation may be denoted as K3. For instance, assume that flight operations A, B, and C exist, where the temporal dependencies are: A before B, and A before C; and a state conflict likelihood exists between B and C. The historical occurrence counts for operations A, B, and C are 20, 5, and 10, respectively. Then, for the candidate test parameter BAC, the corresponding values are: K(BAC)₁=1 (B occurs before A), K(BAC)₂=1 (B and C coexist), and K(BAC)₃=35. For the candidate test parameter CA, the values are: K(CA)₁=1, K(CA)₂=0, and K(CA)₃=30. Subsequently, K1, K2, and K3 corresponding to each candidate test parameter may be normalized respectively (e.g., by Min-Max normalization or Z-score normalization) to obtain dimensionless values of K1, K2, and K3. Finally, a test priority for each candidate test parameter may be determined through weighted summation. The weights may be set based on expert knowledge. For example, a temporal dependency weight of 0.3, a state conflict likelihood weight of 0.5, and a historical occurrence weight of 0.2 may be used. The test priority of the candidate test parameter is calculated as: Test Priority=0.3×K1+0.5×K2+0.2×K3.

Furthermore, the processing device 120 may be configured to determine the test parameter based on test priorities of a plurality of candidate test parameters. For example, the candidate test parameter with the highest test priority may be determined as the test parameter. As another example, a candidate test parameter with a test priority exceeding a threshold may be determined as the test parameter.

In some embodiments, the processing device 120 may be configured to determine the test priorities of the plurality of candidate test parameters based on the temporal dependencies and the state conflict likelihoods in combination with historical flight data of the UAV and a scenario type. For example, in a case where multiple candidate test parameters share the same test priority, the processing device 120 may further rank the plurality of candidate test parameters according to the following order: a multi-operation concurrent stress test, a dual-operation temporal interference test, and a single-operation boundary value test. The candidate test parameter with the highest ranking is designated as the test parameter.

In some embodiments of the present disclosure, determining the test priorities may optimize the allocation of testing resources, ensuring that test parameters with higher failure probabilities and greater impact are tested with higher test priority to improve efficiency.

After the combined test scenario is determined, corresponding test code may be generated through S4. In S5, the processing device 120 may control the UAV to execute the test code in the UAV simulation environment, thereby performing a flight according to the determined test parameter and transmitting a test result.

The test result includes a vulnerability feature and a root cause localization. A vulnerability feature refers to a specific manifestation or attribute that occur when an abnormal situation arises or the behavior deviates from expectations during the UAV system testing process. The vulnerability feature serves as a critical indicator for identifying security vulnerabilities, functional defects, or performance issues in the system. For example, the vulnerability feature may include abnormal flight attitude oscillation, a specific error code triggered during data transmission interruption, or unauthorized command execution. The root cause localization refers to identifying the fundamental cause of problems in the UAV system through in-depth analysis of various anomalies, data, and logs contained in the test result. The root cause localization involves tracing through complex system interactions and runtime behaviors to identify the origin of the vulnerability feature. The root cause may lie in a logic error in code, hardware malfunction, or improper configuration, or the like.

Specifically, the processing device 120 may be configured to perform the following operations:
S5.1, building a UAV simulation sandbox, which includes a physics engine, a sensor noise model, and a communication delay simulation module. The processing device 120 may be configured to determine an overall architecture and a scenario scope of the simulation sandbox based on information such as an environment and a flight mission in the test parameter. For example, the simulation sandbox may be configured with a virtual flight area size and geographic terrain features. Next, the physics engine may be integrated into the simulation sandbox. Parameters of the physics engine may be configured according to the UAV model and flight dynamics parameters specified in the test parameter, so as to accurately simulate forces and motion behaviors of the UAV at different altitudes, speeds, and attitudes. For the sensor noise model, a noise simulation algorithm may be established based on sensor type and accuracy defined in the test parameter, such that the sensor outputs data that conforms to realistic noise characteristics under various environments and flight states. Finally, the communication delay simulation module may be constructed based on communication requirements and network condition parameters in the test parameter, to simulate communication delay, packet loss, and other issues under different distances or interference levels. The physics engine, sensor noise model, and communication delay simulation module may be deeply integrated into the simulation sandbox to ensure coordinated operation of all components. In this way, the simulation sandbox may realistically reproduce UAV operation scenarios based on the test parameter and provide an effective environment for testing.
S5.2, recording system logs of the UAV simulation sandbox, performing root cause analysis via the large language model based on the system logs and the natural language test case to generate a diagnostic report.

The processing device 120 may be configured to issue an execution instruction to the UAV, and the flight control system may control the UAV to perform simulated flights in the virtual environment according to configuration parameters. During the execution of the test task, system logs of the UAV simulation sandbox may be synchronously recorded in real time using a log recording tool. The system logs may include full-process data such as flight control instructions, sensor data, communication information, and module status changes. After the test is completed, the system logs and the natural language test case may be input into the large language model. The natural language test case may be used to clarify the testing objective and the expected result. Then, based on detailed runtime data contained in the system logs, chain of thought prompting engineering may be used to guide the large language model to conduct step-by-step analysis following the logic of “anomaly identification-correlation analysis-cause investigation-root cause localization.” The large language model may extract a vulnerability feature through the analysis, and based on the extracted feature, compare the actual behavior of the system with the expected result defined in the natural language test case. By analyzing data fluctuations, error codes, and operation sequences in the system logs, the large language model may identify the root cause of the problem. Finally, the large language model may generate the diagnostic report in a structured format based on the result of the root cause analysis, including a detailed description of the anomaly, the analytical process, the identified root cause, and corresponding solutions and optimization suggestions.

In some embodiments of the present disclosure, the test parameter generated based on cross-module temporal dependencies and state conflict information may be capable of systematically covering complex scenarios in UAV flight control, such as multi-operation concurrency, resource contention, and state coverage. The test parameter may significantly improve the comprehensiveness of vulnerability detection (e.g., timing logic errors and deadlock risks) and the efficiency of the testing process (e.g., automated generation of high-value test cases). By dynamically verifying abnormal behaviors under combined parameters in the simulation environment, the proposed method may avoid risks associated with real flights while accurately localizing the root causes of vulnerabilities (e.g., code defects in specific modules or protocol flaws in interactions), thereby providing multi-dimensional security assurance for the flight control system.
S6, determining an updating parameter based on results of the vulnerability feature extraction and the root cause localization. In some embodiments, S6 may be executed by the updating module 260.

The updating parameter refers to a new set of parameters determined by adjusting and modifying relevant UAV parameters based on problems identified during system operation or newly introduced requirements. The updating parameter typically involves flight control parameters, sensor parameters, communication parameters, or the like, and is intended to optimize UAV performance, fix vulnerabilities, or meet new functional requirements through corresponding adjustments.

Specifically, the processing device 120 may be configured to perform a detailed analysis of the vulnerability feature to identify aspects of the UAV system in which anomalies have occurred, such as unstable flight attitude or data transmission errors. Meanwhile, the root cause localization may be used to determine the underlying causes of the identified vulnerabilities, which may include defects in flight control algorithms, sensor inaccuracies, or issues in communication protocols. Then, a corresponding parameter updating strategy may be formulated based on the root cause. For example, if the issue lies in the flight control algorithm, the updating parameter may include a modification to attitude control parameters, speed control parameters, or the like to optimize the flight control algorithm's performance. If the issue is caused by sensor inaccuracies, the updating parameter may include calibration parameters or measurement range parameters of the sensor to improve measurement accuracy. If the problem is associated with the communication protocol, parameters such as a communication frequency or data transmission rate may be modified to ensure the stability and reliability of communication. During the process of determining the updating parameter, the overall performance requirements of the UAV and its actual operating environment may also be taken into account. The interdependencies among various parameters may be comprehensively considered to avoid introducing new issues due to parameter adjustments. As a result, a set of updating parameters may be obtained that can effectively resolve the identified vulnerabilities and enhance the performance of the UAV.
S7, updating a flight control parameter of the UAV based on the updating parameter, and controlling the UAV to perform a flight mission in accordance with the updated flight control parameter. In some embodiments, S7 may be executed by the updating module 260.

Specifically, the processing device 120 may be configured to parse and validate the obtained updating parameter to ensure the accuracy and validity of the parameter, for example, by verifying whether the parameter falls within a reasonable value range. The validated updating parameter may then be compared with the current flight control parameters of the UAV to determine which parameters require adjustment. According to the comparison result, the flight control parameter may be modified to the updated value via a parameter adjustment interface of the flight control system. After the update of the flight control parameter is completed, a command to execute the flight mission may be sent to the UAV. The flight control system may control subsystems such as the propulsion system and the attitude control system of the UAV based on the updated flight control parameter, so that the UAV performs the flight mission in accordance with the new parameter requirements. During the flight, the execution of the parameter and the state of the UAV may be continuously monitored, and further fine-tuning of the parameter may be performed if necessary.

In some embodiments, updating the flight control parameter based on the updating parameter may enable automated control and reduce the frequency of command conflicts and failure rates of the UAV while in flight.

FIG. 5 is a flowchart of an exemplary process for constructing a library of operation-code mapping relationships according to some embodiments of the present disclosure. In some embodiments, process 500 in FIG. 5 may be used to implement S1.
S1.1, establishing a library of user operation types.

The library of user operation types refers to a standardized collection of predefined executable instruction types in the flight control system. The library of user operation types essentially refers to a structured database including user operation types and corresponding operation descriptions. The library of user operation types may include the user operations corresponding to takeoff instructions, landing instructions, waypoint upload, emergency braking, and mode switching.

In some embodiments, the processing device 120 may determine the user operation types and construct a data structure using a dictionary or class, and store the user operation types and the corresponding operation descriptions, thereby obtaining the library of user operation types.
S1.2, for each of the user operations, an entry function corresponding to the user operation is located by analyzing a control flow graph, and a code fragment related to the execution of the user operation is extracted using a backward slicing technique.

The control flow graph refers to a graphical model representing transition relationships among code blocks during program execution. Each node of the control flow graph refers to a continuous code block without branching, and each edge refers to control flow transitions such as conditional branches, loops, or function calls. The entry function refers to the first processing function of the flight control system that is triggered in response to the user operation, and is responsible for instruction parsing, parameter verification, and task dispatch.

Merely by way of example, the processing device 120 may analyze a type of the user operation based on the library of user operation types (e.g., takeoff instruction, landing instruction), search for keywords associated with the user operation in the control flow graph, and determine a code region related to the user operation. For example, for a takeoff operation, based on the library of user operation types, the processing device 120 may analyze corresponding keywords such as “takeoff” and “launch,” and search for these in the control flow graph to determine the code region related to the takeoff operation. Furthermore, the processing device 120 may track the control flow graph from the code region associated with the user operation, analyze an execution path of the code, identify a first function that receives the user input and initiates the handling process as a candidate entry function, and determine the entry function by analyzing a function role and boundary condition of the candidate entry function.

As another example, the processing device 120 may locate an entry function corresponding to the user operation based on the control flow graph using tools such as LLVM and CodeQL.

The backward slicing technique refers to a static analysis technique that traces backward from a specific point in a program (e.g., a variable assignment statement) to identify all code statements that influence the data state at that point. Specifically, the processing device 120 may use the entry function as a terminal point, traverse the control flow graph in reverse, obtain nodes and edges traversed during the backward traversal, and extract code corresponding to the nodes and edges as a code fragment related to the execution of the user operation.
S1.3, constructing a data dependency graph and identifying three types of key data nodes involved in the code fragment.

The data dependency graph (DDG) is a directed graph used to represent the dependency relationships between data in code. In a program, there exist various associations between data generation and usage. The data dependency graph visualizes these relationships in the form of nodes and edges. Each node represents a data element in the program, such as a variable, a constant, or an expression; each edge represents a dependency relationship between data, indicating the direction of data flow. Specifically, the processing device 120 may convert the code fragment into an abstract syntax tree, traverse the abstract syntax tree to identify data elements in the code fragment, such as variable declarations, assignment statements, and function calls, then define the data elements as nodes or directed edges, and construct the data dependency graph using a visualization tool based on the defined data elements.

Key data nodes refer to important nodes in the data dependency graph. By analyzing the dependency relationships among these nodes, the behavior and logic of the program can be better understood. In some embodiments, the three types of key data nodes include a state variable, a sensor input, and a user command input.

A state variable is used to describe the state of a system or program during execution, such as information about the flight altitude and speed of a UAV. The state variable may change during program execution and be read and modified in multiple locations, thereby having a significant impact on the operational state and logic of the program. Specifically, the processing device 120 may determine a variable that can be read and modified by a plurality of nodes in the data dependency graph as the state variable.

A sensor input refers to data originating from various hardware sensors. For example, information provided by an accelerometer or a gyroscope in the UAV may affect the decision-making and behavior of the program. Specifically, the processing device 120 may determine a data source node in the data dependency graph, from which a plurality of dependency edges point to other data processing nodes, as a sensor input.

A user instruction input refers to a command input into the system by a user through an interface or command line, such as a takeoff instruction or landing instruction in a UAV control program, and serves as a key factor driving the execution of specific operations in the system. Specifically, the processing device 120 may determine a node that has a direct dependency relationship with a logic node (i.e., a user operation) in the data dependency graph as a user instruction input.
S1.4, clustering and fusing code fragments with data intersections based on the data dependency graph to generate the operation function module containing a complete chain of control corresponding to the user operation

The code fragments with data intersections refer to the code fragments that involve the same variables and/or functions. For example, modifying the home point and executing a mission are two user operations of the UAV. The operation of modifying the home point affects the home variable of the UAV. During mission execution, the mission planning determines the absolute height of the task based on the home altitude and the relative altitude of the uploaded task. The data flow also passes through the home variable. Therefore, the code fragments corresponding to these two operations are the code fragments with data intersections. Specifically, the processing device 120 may determine the code fragments involving the same data nodes as the code fragments with data intersections based on the data dependency graph.

Furthermore, the processing device 120 may merge the code fragments with data intersections to form an initial cluster and a merged code. The merged code may be analyzed to optimize data transmission and sharing among different code fragments. During the merging process, conflicts and duplicate sections within the merged code may be addressed to ensure correct execution of the merged code. For example, when two code fragments contain initialization operations for the same variable, a decision may be made based on the specific context to retain one initialization or perform necessary modifications in order to avoid data errors caused by repeated initialization. The processing device 120 may then construct a complete chain of control based on logical relationships among the code fragments, such that data is transmitted and processed in a correct order across the relevant nodes. Finally, the processing device 120 may encapsulate the merged code having the complete chain of control into the operation function module and provide clearly defined input and output interfaces.
S1.5, adding metadata tags for each operation function module.

The metadata tags refer to data tags configured to describe information related to the operation function module. The metadata tags may provide key attributes and features of the operation function module, assisting developers, maintainers, or other relevant personnel in more quickly and accurately understanding the functionality, behavior, and usage of the operation function module. In some embodiments, the metadata tags may include a type of operation, a range of lines of code, a set of input and output parameters, and a list of associated hardware devices. Specifically, the processing device 120 may add the metadata tags for each operation function module by using an analysis tool (e.g., a code editor), thereby establishing the library of operation-code mapping relationships.

FIG. 6 is a flowchart of an exemplary process for generating structured natural language semantic descriptions according to some embodiments of the present disclosure. In some embodiments, the process 600 in FIG. 6 may be used to implement S2.
S2.1, designing a structured description template.

The structured description template refers to a format framework used to standardize the structured natural language semantic descriptions of code fragments. The structured description template defines a set of fields with clear semantics and structures, thereby ensuring consistency, accuracy, and completeness of the structured natural language semantic descriptions for both human understanding and machine processing. In some embodiments, the structured description template comprises five fields: a functional intent, an input parameter constraint, an output behavioral expectation, an exception handling mechanism, and a hardware interaction interface.

Specifically, the processing device 120 may determine a format and constraint for each field to ensure standardized and accurate descriptions. The fields may be arranged in a logical order to enhance readability and usability.
S2.2, the code fragment and contextual annotations are input into the large language model, and initial descriptions are generated based on the structured description template using chain of thought prompting engineering.

The contextual annotations refer to textual explanations added to the code fragment, which are used to explain the function, purpose, usage, and related background information of the code fragment.

The chain of thought prompting engineering refers to a technique that guides the large language model to perform thinking and reasoning in a specific logical sequence, so as to generate more accurate, detailed, and requirement-conforming results. The chain of thought prompting engineering provides a series of logically connected prompts to enable the large language model to analyze problems step by step, decompose complex tasks into multiple sub-steps, and produce more complete and refined outputs.

The initial descriptions refer to a natural language semantic description of the code fragment that has not been verified for completeness. Specifically, the processing device 120 may construct a series of logically ordered chain of thought prompts based on the fields of the structured description template (e.g., summarizing the function first, then analyzing input parameters), and sequentially input the code fragment, the contextual annotations, and the prompts into the large language model. The large language model may gradually generate descriptions based on the prompts and fill the generated descriptions into the structured description template to obtain the initial descriptions.
S2.3, designing a reflection mechanism under the framework of the large language model to verify the completeness of the initial descriptions, and triggering an iterative correction instruction for the initial descriptions that miss mandatory fields, thereby generating the structured natural language semantic descriptions.

The reflection mechanism refers to a self-evaluation mechanism used when the large language model performs tasks to verify whether the output results meet the expected requirements and are complete and accurate. The reflection mechanism evaluates and verifies the generated results based on preset rules and standards, identifies existing issues, and initiates appropriate corrective actions.

In the structured description template, mandatory fields are the information that must be included to comprehensively and accurately describe the object. If the initial descriptions generated by the large language model lack one or more of these mandatory fields, the initial descriptions are considered to be missing mandatory fields. For example, the five fields—functional intent, input parameter constraint, output behavioral expectation, exception handling mechanism, and hardware interaction interface—are mandatory fields; if the generated initial descriptions lack content related to the functional intent, such descriptions are considered to be missing a mandatory field.

The iterative correction instruction refers to an instruction that requires the large language model to re-evaluate the problem and to supplement or correct the previously generated initial descriptions so as to meet completeness and accuracy requirements.

Specifically, the processing device 120 performs a traversal check on the initial descriptions generated by the large language model to determine whether all mandatory fields are included. If any mandatory field is found missing, the missing field information is compiled into an iterative correction instruction and sent back to the large language model for completion. The corrected the initial descriptions are then verified again. If mandatory fields are still missing, the correction process is repeated until the initial descriptions fully meet the requirements, and the final result is output as the structured natural language semantic descriptions.

FIG. 7 is a flowchart of an exemplary process for generating a natural language test case according to some embodiments of the present disclosure. In some embodiments, the process 700 in FIG. 7 may be used to implement S3.
S3.1, constructing a cross-module association graph using the large language model and performing the correlation analysis to analyze temporal dependencies and state conflict likelihoods between the user operations to generate an analysis result.

The cross-module association graph is a structure for graphically representing the association relationships among multiple operation function modules. The cross-module association graph presents the interconnections among the operation function modules in terms of functionality, data, and control, and facilitates a comprehensive understanding of the collaboration patterns and dependency relationships among the operation function modules in the system. The cross-module association graph comprises a plurality of nodes and multiple edges, each node representing one operation function module, and each edge representing the association relationship between nodes. Each edge is a directed edge, and the direction of each edge indicates the temporal sequence. Specifically, the processing device 120 performs correlation analysis based on the multi-dimensional semantic features of the operation function modules, extracts association information including functional associations, data flow directions, and control dependencies among the operation function modules, and inputs the extracted association information into the large language model. The large language model integrates the association information among the operation function modules and outputs the cross-module association graph.

The temporal dependencies among user operations refers to the execution order constraints among multiple user operations in terms of time, where certain operations must be executed before or after others to ensure proper system behavior. For example, modifying the home point during task execution may trigger a task execution exception. Therefore, the temporal dependencies among the user operations in this case is: uploading the task→executing the task→modifying the home point.

The state conflict likelihood among user operations refers to the possibility that multiple user operations may cause the flight control system to enter mutually contradictory states, resulting in system anomalies or errors. For example, issuing a landing instruction when the unmanned aerial vehicle has not taken off, or switching to task execution mode before uploading the task route, may result in system anomalies or errors

In some embodiments, the processing device 120 generates the temporal dependencies and the state conflict likelihoods corresponding to different flight control operations based on the multi-dimensional semantic features corresponding to different flight phases and the cross-module association graph. The temporal dependencies corresponding to the flight control operations refer to the temporal dependencies among user operations in different flight phases. The state conflict likelihoods corresponding to the flight control operations refer to information indicating the state conflict likelihood among user operations in different flight phases.

In some embodiments, the processing device 120 inputs the cross-module association graph and the multi-dimensional semantic features corresponding to the nodes in the cross-module association graph (i.e., the operation function modules) into a graph neural network (GNN). The graph neural network outputs the temporal dependencies and the state conflict likelihoods. Specifically, the graph neural network analyzes the operation function modules corresponding to the user operations and the interactions among the operation function modules based on the cross-module association graph and the multi-dimensional semantic features, identifies the temporal dependencies among nodes, and determines which user operations are required to be executed in a specific sequence. Meanwhile, the graph neural network examines the system states potentially triggered by different user operations and evaluates the existence of state conflict likelihoods. For example, one user operation may set the system state to J, while another operation requires the system to be in a non-J state, which may lead to a potential state conflict.

In some embodiments of the present specification, processing the cross-module association graph through the graph neural network (GNN) enables efficient modeling of complex module interaction relationships and significantly improves the accuracy of temporal dependency and conflict analysis. In addition, the parallel computation capability of the GNN enhances the inference efficiency of large-scale graphs and supports dynamic adaptation to different flight control system graph topologies.

In some embodiments, the graph neural network is obtained through training based on a plurality of training samples. The training samples may be historical cross-module association graphs. The plurality of training samples are obtained using the large language model. For example, the large language model generates the training samples based on historical code fragments corresponding to a plurality of historical operation function modules. The historical cross-module association graphs are obtained based on the large language model and historical code fragments corresponding to the plurality of historical operation function modules, which is similar to the process described in S1 to S3 where the cross-module association graph is obtained based on the large language model and the code fragments corresponding to the plurality of operation function modules. The plurality of training labels corresponding to the plurality of training samples are determined based on historical flight control conflict records.
S3.2, generating the combined test scenario based on the multi-dimensional semantic features of the operation function modules;

As described above, a combined test scenario is formed by combining a plurality of operation function modules to simulate complex situations that may occur during actual system operation. In some embodiments, the combined test scenario comprises three types of scenarios: single-operation boundary value test, dual-operation temporal interference test, and multi-operation concurrent stress test.

The single-operation boundary value test refers to testing a single operation function module by selecting the boundary values of an input parameter (e.g., maximum value, minimum value, critical value) to verify the correctness and stability of the operation function module under boundary conditions, ensuring that the operation function module does not exhibit abnormal behavior or produce erroneous results under boundary conditions. For example, taking the open-source flight control systems PX4-autopilot and ArduPilot as examples, unmanned aerial vehicles have hundreds of configurable parameters (such as pitch angle, motor speed, return altitude, etc.). However, some values in the parameter range allowed in the code are not reasonable in the physical world. For example, configuring the maximum boundary value of the pitch angle may cause the UAV to crash.

The dual-operation temporal interference testing is a type of combined testing performed on two operation function modules, focusing on the impact of the execution order and time interval of the operation function modules on the system, and detecting whether functional failures, data errors, or system instability occur due to timing issues.

The multi-operation concurrent stress testing refers to simultaneously executing a plurality of operation function modules in parallel to simulate the running state of the system under high load and high stress, in order to evaluate the system's performance, resource utilization, and whether issues such as data conflicts or deadlocks may occur when multiple operations are performed concurrently.

Specifically, the processing device 120 analyzes the multi-dimensional semantic features of the plurality of operation function modules and extracts key information from dimensions such as functional intent, input and output parameters, data processing logic, and hardware interaction interfaces. For the single-operation boundary value test scenario, based on the input parameter constraint dimension, boundary values are determined for the input parameters of each operation function module, and combined test scenarios are designed for the execution of individual operation function modules under boundary conditions; in the construction of the dual-operation temporal interference test scenario, based on the functional correlation and data dependency characteristics among the operation function modules, operation pairs with potential temporal dependencies are identified, and combined test scenarios under different execution sequences are designed; for the multi-operation concurrent stress test scenario, in combination with system performance requirements and module interaction characteristics, a plurality of interrelated operation function modules are selected to simulate operation execution under high-concurrency conditions. By comprehensively utilizing the multi-dimensional semantic features of each operation function module, the combined test scenarios covering the single-operation boundary value test, the dual-operation temporal interference test, and the multi-operation concurrent stress test are systematically and thoroughly generated, thereby effectively covering various potential issues that may exist in the system.
S3.3, constructing a chain of test steps based on the combined test scenario and the analysis result of the user operations.

The chain of test steps refers to a sequence of test steps arranged in a specific order, where the steps are interrelated and collectively form a complete testing process for verifying the functionality and performance of the system under a specific scenario. In some embodiments, the chain of test steps comprises a precondition trigger, an execution interruption, and a post-state verification. The precondition trigger refers to a series of conditions that must be met before executing the test steps, serving as the basis for subsequent steps to be performed normally, such as the system being in a specific state or certain data being initialized. The execution interruption refers to the situation where the test steps cannot be completed as expected due to various causes (e.g., exceptions, resource limitations), leading to early termination. The post-state verification refers to checking and verifying the state of the system after completing the test steps, to ensure that the system has achieved the expected state, such as verifying whether the data has been correctly updated, whether the system is in a stable state, and the like.

For example, the chain of test steps may include: “upload a mission route, enter mission mode, and modify the home position after the UAV reaches waypoint 2.”

Specifically, the processing device 120 may determine the specific objectives and expected results for each combined test scenario. Further, the processing device 120 may determine the preconditions for each test step, such as ensuring that the system is in a specific initialized state or that certain data has been prepared before executing an operation, and treat these preconditions as the starting part of the chain of test steps. Subsequently, the processing device 120 decomposes the user operations into specific execution steps according to the execution order and logical relationship, thereby constructing the main body of the chain of test steps. During the construction process, the processing device 120 considers possible execution interruptions and sets corresponding exception handling mechanisms and recovery steps to ensure the robustness of the combined test scenario. Finally, for each test step execution, the processing device 120 determines the content and method for post-state verification, and appends them to the end of the chain of test steps to verify whether the system has reached the expected result. Through the above steps, a complete, coherent, and operational chain of test steps is constructed.
S3.4, inputting the chain of test steps into the large language model to obtain the natural language test case.

Specifically, the large language model, leveraging its powerful capabilities in semantic understanding and natural language generation, performs in-depth analysis and processing on the chain of test steps. The logic, operations, and other relevant information contained in the chain of test steps are transformed into fluent and coherent natural language descriptions. The final output is a natural language test case, which facilitates intuitive understanding and execution of the test operations by testing personnel.

The basic concepts have been described above, and it is apparent to those skilled in the art that the foregoing detailed disclosure serves only as an example and does not constitute a limitation of this specification. While not expressly stated herein, a person skilled in the art may make various modifications, improvements, and amendments to this specification. Those types of modifications, improvements, and amendments are suggested in this specification, so those types of modifications, improvements, and amendments remain within the spirit and scope of the exemplary embodiments of this specification.

Also, the specification uses specific words to describe embodiments of the specification. such as “an embodiment”, “an embodiment”, and/or “some embodiment” means a feature, structure, or characteristic associated with at least one embodiment of the present specification. Accordingly, it should be emphasized and noted that “one embodiment” or “an embodiment” or “an alternative embodiment” in different places in this specification do not necessarily refer to the same embodiment. In addition, certain features, structures, or characteristics in one or more embodiments of the present specification may be suitably combined.

Additionally, the order of processing elements and sequences, the use of numerical letters, or the use of other names described herein are not intended to qualify the order of the processes and methods of the present specification, unless expressly stated in the claims. While some embodiments of the invention that are currently considered useful are discussed in the foregoing disclosure by way of various examples, it is to be understood that such details serve only illustrative purposes, and that additional claims are not limited to the disclosed embodiments!, rather, the claims are intended to cover all amendments and equivalent combinations that are consistent with the substance and scope of the embodiments of this specification. For example, although the implementation of various components described above may be embodied in a hardware device, it may also be implemented as a software only solution, e.g., an installation on an existing server or mobile device.

Similarly, it should be noted that in order to simplify the presentation of the disclosure of this specification, and thereby aid in the understanding of one or more embodiments of the invention, the foregoing descriptions of embodiments of this specification sometimes group multiple features together in a single embodiment, accompanying drawings, or a description thereof description thereof. However, this method of disclosure does not imply that the objects of the present specification require more features than those mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified in some examples by the modifiers “about”, “approximately”, or “substantially”.”, “approximately”, or “generally” is used in some examples. Unless otherwise noted, the terms “about,” “approximate,” or “approximately” indicates that a ±20% variation in the stated number is allowed. Correspondingly, in some embodiments, the numerical parameters used in the specification and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present specification are approximations, in specific embodiments such values are set to be as precise as practicable.

For each of the patents, patent applications, patent application disclosures, and other materials cited in this specification, such as articles, books, specification sheets, publications, documents, and the like, are hereby incorporated by reference in their entirety into this specification. Application history documents that are inconsistent with or conflict with the contents of this specification are excluded, as are documents (currently or hereafter appended to this specification) that limit the broadest scope of the claims of this specification. It should be noted that in the event of any inconsistency or conflict between the descriptions, definitions, and/or use of terms in the materials appended to this specification and those set forth herein, the descriptions, definitions and/or use of terms in this specification shall control. use shall prevail.

Finally, it should be understood that the embodiments described in this specification are only used to illustrate the principles of the embodiments of this specification. Other deformations may also fall within the scope of this specification. As such, alternative configurations of embodiments of the present specification may be viewed as consistent with the teachings of the present specification as an example, not as a limitation. Correspondingly, the embodiments of the present specification are not limited to the embodiments expressly presented and described herein.

What is claimed is:

1. A method for performing vulnerability detection on a flight control system of an unmanned aerial vehicle (UAV) based on a data flow analysis method and a large language model (LLM), comprising:
S1, extracting operation function modules associated with user operations in the flight control system via the data flow analysis method, and establishing a library of operation-code mapping relationships;
S2, for each operation function module, generating structured natural language semantic descriptions of a code fragment corresponding to the operation function module using the large language model to form a multi-dimensional semantic feature;
S3, constructing a combined test scenario and generating a natural language test case based on the combined test scenario by performing a correlation analysis on the multi-dimensional semantic features of the operation function modules;
S4, transforming the natural language test case into executable test code via reverse semantic mapping;
S5, executing the test code in a UAV simulation environment, obtaining logs of the flight control system while it is running, and performing vulnerability feature extraction and root cause localization using the large language model.

2. The method of claim 1, wherein the S1 comprises:
S1.1, establishing a library of user operation types, the library of user operation types comprising the user operations corresponding to takeoff instructions, landing instructions, waypoint upload, emergency braking, and mode switching;
S1.2, for each of the user operations, locating an entry function corresponding to the user operation by analyzing a control flow graph, and extracting a code fragment related to the execution of the user operation using a backward slicing technique;
S1.3, constructing a data dependency graph identifying three types of key data nodes involved in the code fragment, the three types of key data nodes comprising a state variable, a sensor input, and a user command input;
S1.4, clustering and fusing code fragments with data intersections based on the data dependency graph to generate the operation function module containing a complete chain of control corresponding to the user operation;
S1.5, adding metadata tags for each operation function module, the metadata tags comprising a type of operation, a range of lines of code, a set of input and output parameters, and a list of associated hardware devices.

3. The method of claim 1, wherein the structured natural language semantic descriptions in S2 are generated by:
S2.1, designing a structured description template, the structured description template comprising five fields: a functional intent, an input parameter constraint, an output behavioral expectation, an exception handling mechanism, and a hardware interaction interface;
S2.2. inputting the code fragment into the large language model together with contextual annotations, and generating initial descriptions based on the structured description template using chain of thought prompting engineering;
S2.3, designing a reflection mechanism to verify the completeness of the initial descriptions under the framework of the large language model, and triggering an iterative correction instruction for the initial descriptions that miss mandatory fields, thereby generating the structured natural language semantic descriptions.

4. The method of claim 1, wherein the natural language test case in S3 is generated by:
S3.1, constructing a cross-module association graph using the large language model and performing the correlation analysis to analyze temporal dependencies and state conflict likelihoods between the user operations to generate an analysis result;
S3.2, generating the combined test scenario based on the multi-dimensional semantic features of the operation function modules, the combined test scenario comprising three types of scenarios including a single-operation boundary value test, a dual-operation temporal interference test, and a multi-operation concurrent stress test;
S3.3, constructing a chain of test steps based on the combined test scenario and the analysis result of the user operations;
S3.4, inputting the chain of test steps into the large language model to obtain the natural language test case.

5. The method of claim 1, wherein the S4 comprises:
S4.1, constructing a JSON interface knowledge base for call functions of functions of the UVA, and providing a standardized interface description for the large language model, wherein the standardized interface description comprises a function name, a parameter type, a parameter semantic constraint, a return value structure, and an exception handling strategy;
S4.2, mapping the natural language test case to an executable Python script;
S4.3, implementing a dynamic semantic validation on the executable Python script during code generation and triggering an iterative correction process on the executable Python script performed by the large language model in response to a failed validation result.

6. The method of claim 1, wherein the S5 comprises:
S5.1, building a UAV simulation sandbox, which includes a physics engine, a sensor noise model, and a communication delay simulation module;
S5.2, recording system logs of the UAV simulation sandbox, performing root cause analysis via the large language model based on the system logs and the natural language test case to generate a diagnostic report.

7. The method of claim 1, wherein the method is realized by the following modules:
an operation code fragment extraction module configured to generate a library of operation-code mapping relationships by the data flow analysis method;
a multi-stage large language model processing module configured to generate the multi-dimensional semantic features and the combined test scenarios, and to analyze the logs;
a code transformation module, integrating JSON interface knowledge base with semantic checking rules;
a simulation sandbox module configured to obtain the logs;
a vulnerability diagnostics module configured to perform the vulnerability feature extraction and the root cause localization using the large language model.

8. The method of claim 1, wherein the method further comprises:
S6, determining an updating parameter based on results of the vulnerability feature extraction and the root cause localization;
S7, updating a flight control parameter of the UAV based on the updating parameter, and controlling the UAV to perform a flight mission in accordance with the updated flight control parameter.

9. The method of claim 4, wherein the method further comprises:
extracting, based on the library of operation-code mapping relationships, the code fragments corresponding to the operation function modules in different flight phases, generating the structured natural language semantic descriptions based on the code fragments, and generating the structured natural language semantic descriptions to form the multi-dimensional semantic feature;
generating temporal dependencies and state conflict likelihoods corresponding to different flight control operations based on the multi-dimensional semantic features corresponding to the different flight phases through the cross-module association graph;
determining a test parameter corresponding to the combined test scenario based on the temporal dependencies and the state conflict likelihoods.

10. The method according to claim 9, wherein
the cross-module association graph includes a plurality of nodes and a plurality of edges, each node including a multi-dimensional semantic feature, each edge including an association relationship between nodes, each edge being a directed edge, and the direction of each edge indicating a temporal sequence;
the generating temporal dependencies and state conflict likelihoods corresponding to different flight control operations based on the multi-dimensional semantic features corresponding to the different flight phases through the cross-module association graph, comprising:
determining the temporal dependencies and the state conflict likelihoods through a graph neural network (GNN) based on the cross-module association graph.

11. The method of claim 9, wherein the graph neural network is obtained based on a plurality of training samples training;
the plurality of training samples obtained based on the large language model;
a plurality of training labels corresponding to the plurality of training samples are determined based on historical flight control conflict records.

12. The method of claim 4, wherein
the combined test scenario is generated based on a test parameter;
the test parameter is determined by:
randomly generating a plurality of candidate test parameters;
determining test priorities for the plurality of candidate test parameters based on the temporal dependencies, the state conflict likelihoods, and historical flight data of the UAV;
determining the test parameter based on the test priorities of the plurality of candidate test parameters.

13. The method of claim 12, wherein the determining test priorities for the plurality of candidate test parameters based on the temporal dependencies, the state conflict likelihoods, and historical flight data of the UAV comprises:
determining the test priorities of the plurality of candidate test parameters based on the temporal dependencies, the state conflict likelihoods, the historical flight data and a scenario type of the UAV.
